(19) United States
(12) Patent Application Publication
(10) Pub. No.: US 2017/0053340 A1
(43) Pub. Date: Feb. 23, 2017

(54) ELECTRIC COMMERCE SUPPORT SYSTEM

(71) Applicant: AliveCast Inc., Fukuoka (JP)

(72) Inventors: Osamu NAKAMURA, Fukuoka (JP); Tatsuhiko ITO, Fukuoka (JP)

(73) Assignee: AliveCast Inc.

(21) Appl. No.: 15/344,895

(22) Filed: Nov. 7, 2016

Related U.S. Application Data
(63) Continuation of application No. PCT/JP2015/064062, filed on May 15, 2015.

(30) Foreign Application Priority Data
May 16, 2014 (JP) 2014-102464

(51) Int. Cl. G06Q 30/06; H04N 1/00; H04N 1/32; G06K 19/06

(52) U.S. Cl. CPC G06Q 30/0633; G06K 19/06037; H04N 1/00307; H04N 1/32133; G06Q 50/01

(57) ABSTRACT

An electric commerce support system that an introducer does not have to specialized knowledge and further that an orderer can comfortably order an/a article/service is provided. In an electric commerce support system, a smartphone operated by the orderer and an electric commerce support server are connected to each other via the Internet. Firstly, the orderer reads article/service identification information from a two-dimensional bar code displayed on a flier using the smartphone to order the article/service. Secondly, the orderer becomes an introducer and further operates the smartphone to display a two-dimensional bar code showing the ordered article/service based on order history. Thirdly, a new orderer operating another smartphone reads the two-dimensional bar code to place order therefor to the electric commerce support server. Upon the new orderer has placed the order, the electric commerce support server gives a reward to the introducer. The introducer doses not have to possess specialized knowledge, and can get the reward when the introducer has introduced the ordered article/service.

### BACKGROUND OF THE INVENTION

1. Field of the Invention

The present invention relates to an electric commerce support system. Firstly, a first orderer orders an/a article/service. Secondly, the first orderer as an introducer introduces the ordered article/service to a second orderer. Thirdly, the second orderer orders the same introduced article/service. And then, the introducer, who is the first orderer, can get a success reward from the electric commerce support system.

2. Description of the Related Art

An affiliate is a success reward type advertisement system that gives a success reward to an owner of Web pages when a browser has purchased an item on advertiser's site using the advertiser's banner published on the Web pages.

The Internet has been widely used. And, in many cases, the general public who does not belong to an advertising agency inserts banner advertisement or the like onto his/her own homepages to form the affiliate.

Reference 1 is known as prior art regarding such an affiliate.

An advertisement delivery apparatus disclosed in Reference 1 (Japanese patent application Laid-open on No. 2006-113884) performs:

generating a URL of a mobile site corresponding to advertisement contents, and a QR code (trademark) containing an acquired affiliate ID;

transmitting an image data of the QR code with the selected advertisement contents to a computer used by a user; and

calculating a success reward to be given to the affiliate based on information including the URL of the mobile site which is a redirect destination, transmitted by a browser phone having shot the QR code displayed by a browser application running on the (personal) computer and the affiliate ID (tracking data).

[Reference 1] Japanese patent application Laid-open on No. 2006-113884

### OBJECTS AND SUMMARY OF THE INVENTION

According to the advertisement delivery apparatus disclosed in Reference 1, however, the user merely displays information including the optical read information such as a QR Code and the affiliate ID for identifying the introducer on a page. Therefore, it is difficult for an introduced person to surely judge whether or not he/her should be an orderer to purchase the introduced article/service.

Furthermore, according to the advertisement delivery apparatus disclosed in Reference 1, the user should make a copy of scripts for requesting a two-dimensional bar code transmitted in response to request from the user's personal computer with copy & paste functions, and transfer the copy onto an HTML document of medium pages in place using a text editor application or the like.

Accordingly, the user as an affiliate must be an expert conversant with HTML documents.

In view of the above, an object of the present invention is to provide an electric commerce support system that an introducer does not have to possess specialized knowledge, and further that an orderer can order an/a article/service at ease.

An electric commerce support system according to the present invention, comprises: a first terminal operated by an introducer introducing an/a article/service that the introducer has been ordered; a second terminal operated by an orderer ordering the introduced article/service in response to introduction from the first terminal; and a server supporting electronic commerce that gives the introducer a success reward in response to order from the second terminal, wherein: the first terminal comprises: a first unit requesting the server to transmit an order history; and a second unit issuing optical read information including first identification information identifying the ordered article/service based on the order history transmitted from the server, and second identification information identifying the introducer, the second terminal comprises: a third unit reading the optical read information issued by the second unit; and a fourth unit generating order information according to the optical read information read by the third unit to transmit the generated order information to the server, thereby requesting order; and the server comprises a fifth unit giving the introducer the success reward according to the second identification information included in the order information transmitted by the fourth unit.

According to the present invention, in response to request from the first unit of the first terminal operated by the introducer, the server transmits the order history thereto.

Based on the transmitted order history, the second unit issues the optical read information including the first identification information identifying the ordered article/service and the second identification information identifying the introducer.

The second terminal operated by the orderer reads this optical read information with the third unit, and the fourth unit thereof generates the order information based on the optical read information, and transmits it to the server.

Accordingly, the introducer can present the optical read information using the order history to the orderer, and can get the success reward when the orderer has placed order.

The orderer also can order the ordered article/service introduced by the introducer.

It is preferable that the order information further includes orderer identification information identifying the orderer; and the fifth unit of the server gives the orderer the success reward according to the orderer identification information.

With this arrangement, the orderer can get the success reward when having ordered the ordered article/service introduced by the introducer. In other words, the orderer is promoted to actively place order due to the order history from the introducer.

It is also preferable that the first terminal further comprises a sixth unit displaying the optical read information issued by the second unit.

With this arrangement, the third unit of the second terminal reads the optical read information displayed on the sixth unit of the first terminal. So, the orderer can easily order the ordered article/service.

It is also preferable that the first terminal further comprises a seventh unit making a printer print the optical read information issued by the second unit.

With this arrangement, the introducer can print and distribute the optical read information showing the ordered article/service to be recommended to others in large quantities using the printer. So, the introducer can widely get a chance to acquire the success reward.

In addition, the third unit of the second terminal reads the optical read information printed by the printer using the seventh unit of the first terminal. So, the orderer can easily order the ordered article/service.

It is also preferable that the first terminal further comprises an eighth unit transmitting the optical read information issued by the second unit via e-mail.

With this arrangement, the introducer can distribute the optical read information showing the ordered article/service to be recommended to others by the e-mail. So, the introducer can widely get a chance to acquire the success reward.

It is also preferable that the first terminal further comprises a ninth unit transmitting the optical read information issued by the second unit to a site where manages social network services.

With this arrangement, the introducer can upload to the site managing the social networking services the optical read information showing the ordered article/service to be recommended to others, thereby spreading it. So, the introducer can widely get a chance to acquire the success reward.

According to the present invention, the introducer can present to the orderer the optical read information due to the order history. The introducer can also get the success reward when the orderer has placed order.

Furthermore, the orderer can place order for the article/service ordered by the introducer.

In the above, the introducer does not have to possess specialized knowledge, and the orderer can order the article/service at ease.

### BRIEF DESCRIPTION OF THE DRAWINGS

FIG. 1 shows an electric commerce support system in Embodiment 1 according to the present invention;

FIG. 2 is a block diagram of a smartphone operated by an orderer using the electric commerce support system shown in FIG. 1;

FIG. 3 is a block diagram of an electric commerce support server installed in an electronic commerce office using the electric commerce support system shown in FIG. 1;

FIG. 4 is a flow chart explaining operations when order for an/a article/service is placed using the electric commerce support system shown in FIG. 1;

FIG. 5 shows an example of an order screen;

FIG. 6 is a flow chart explaining operations when the order for the article/service is canceled using the electric commerce support system shown in FIG. 1;

FIG. 7 shows an example of an order history screen;

FIG. 8 shows an example of an operation screen;

FIG. 9 is a flow chart explaining operations when an introducer introduces an/a article/service with an order history, and when an orderer orders the introduced article/service using the electric commerce support system shown in FIG. 1;

FIG. 10 shows an example where a two-dimensional bar code is displayed according to the order history;

FIG. 11A shows contents printed on a flier including bar code information and order information; and

FIG. 11B shows contents displayed on the smartphone including the bar code information and the order information.

### BRIEF DESCRIPTION OF SYMBOLS

10: Electric commerce support system
20: Smartphone
21: Wireless communication unit
22: Reading unit
23: Browsing unit
24: Request-informing unit
25: Display unit
26: Input unit
27: Optical read information-generating unit
28: Positioning unit
29a: Print-controlling unit
29b: Mail-transmitting unit
30: Electric commerce support server
31: Communication unit
32: Screen-transmitting unit
33: History-managing unit
34: Order-handling unit
35: Registration unit
36: Reward-giving unit
37: Display unit
38: Input unit
39: Storage unit
P1: Order screen
P2: Order history screen
P3: Operation screen
B1: “Purchase” button
B2: “Order history” icon
B3: “Cancel to purchase” button
B4: “Recommend to friends” button
C0: Flier
Q0, Q1: Two-dimensional bar code
W0: The Internet

### DETAILED DESCRIPTION OF THE PREFERRED EMBODIMENTS

### Embodiment 1

With reference to the accompanying drawings, an electric commerce support system in Embodiment 1 according to the present invention will now be explained.

An electric commerce support system 10 in Embodiment 1 enables to easily place order for an/a article/service based on optical read information displayed on an advertising medium.

In the electric commerce support system 10, a smartphone 20 and an electric commerce support server 30 are connected via a network (e.g. the Internet W0). The smartphone 20 functions as both an introducer's terminal (a first terminal) operated by the introducer and an orderer's terminal (a second terminal) operated by the orderer.

And, the electric commerce support server 30 is a managing apparatus installed in an electronic commerce office.

The smartphone 20 is a cell phone comprising: a telephone function; an Internet-accessing function; a function of reading optical read information (e.g. a two-dimensional bar code); and so on.

In this Embodiment, programs are installed onto the smartphone, which is a kind of computer, to make thereof function as both the introducer's terminal and the orderer's terminal.

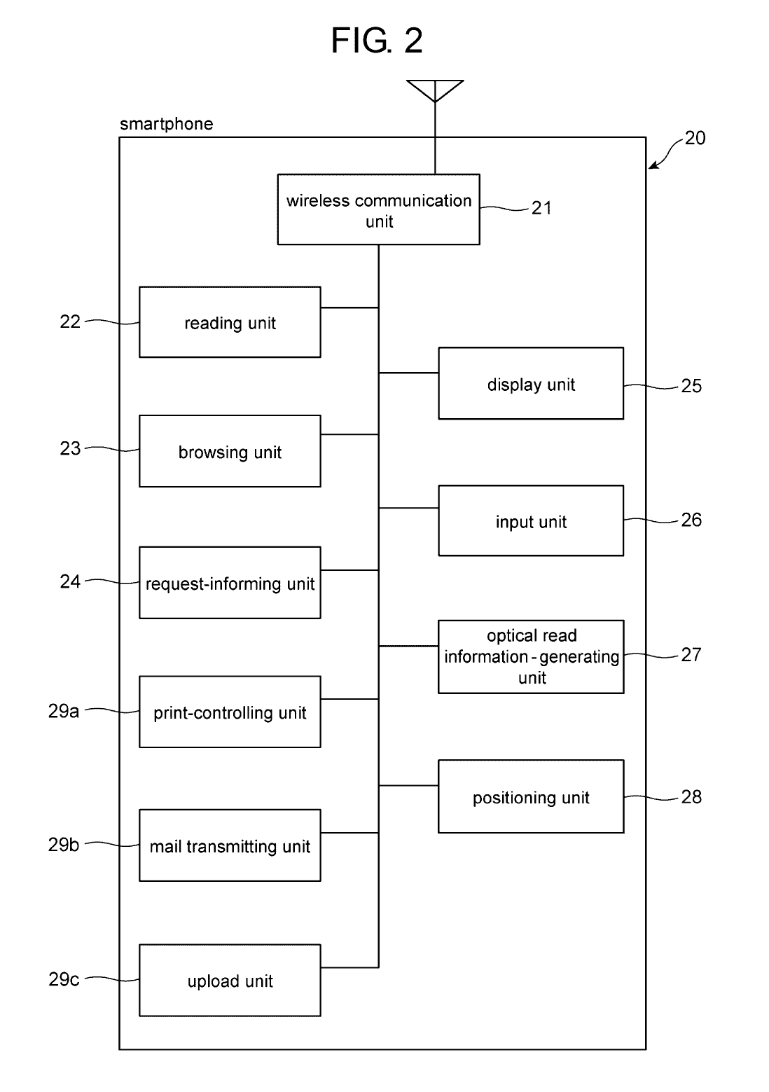

FIG. 2 shows the smartphone 20 functioning as both the introducer's terminal and the orderer's terminal. However, not units for the telephone function or the like but only main units are illustrated therein.

As shown in FIG. 2, the smartphone 20 comprises: a wireless communication unit 21; a reading unit 22; a browsing unit 23; a request-informing unit 24; a display unit 25; an input unit 26; an optical read information-generating unit 27; a positioning unit 28; a print-controlling unit 29a; a mail-transmitting unit 29b; and an upload unit 29c.

The wireless communication unit 21 wirelessly communicates with repeater stations and base stations which are accessible to the Internet W0, while transmitting data to the Internet W0 and receiving data from the Internet W0.

The reading unit 22 functions as a third unit reading bar code information including: the optical read information printed on the advertising medium; and article/service identification information (first identification information) from optical read information displayed on another smartphone 20.

The reading unit 22 transmits the read bar code information to an address indicating the electric commerce support server 30 on the network with: person identification information (orderer identification information for identifying an orderer) for identifying an operator of the smartphone 20; introducer identification information (second identification information) for identifying an introducer; and positional information including items of longitude and latitude showing a location of the smartphone 20.

If the network is the Internet W0, the address on the network may be, for example, an IP address and/or a URL.

The IP address and/or the URL are/is automatically set up by installing orderer's program, and are/is stored on the reading unit 22 to be set up in itself (the smartphone 20).

The address indicating the electric commerce support server 30 on the network may be stored on a unit other than the reading-unit 22, and/or may be stored on a storage unit (not shown).

The browsing unit 23 receives image information from the electric commerce support server 30 to display it on the display unit 25.

When the orderer presses a button on a display screen generated by the browsing unit 23 based on the image information, the request-informing unit 24 transmits a notice corresponding to the pressed button to the electric commerce support server 30 as request for order.

When the button on the display screen displayed on the display unit 25 is a button requesting an order history, the request-informing unit 24 functions as a history-requesting unit (a first unit).

When the button on the display screen displayed on the display unit 25 is another button requesting order, the request-informing unit 24 functions as an order-requesting unit (a fourth unit).

The display unit 25 functions as a sixth unit displaying data (optical read information, or the like) to be displayed thereon.

The display unit 25 may be an LCD and/or an organic EL.

The input unit 26 may be a touch panel provided on a front surface of the display unit 25.

The optical read information-generating unit 27 functions as a second unit generating optical read information based on article/service information from the electric commerce support server 30.

When the article/service information transmitted from the electric commerce support server 30 is based on an order history, the optical read information-generating unit 27 generates optical read information including: article/service information containing article/service identification information indicating an ordered article/service; and person identification information (introducer identification information) for identifying an introducer.

The optical read information may be described with not only white and black one/two-dimensional bar code, but also with: another one/two-dimensional bar code having more amounts of information according to colorization; and a dot-matrix pattern coded utilizing minimum dots.

In this Embodiment 1, a QR Code, which is an example of a white and black two-dimensional bar code, is adopted for describing the optical read information.

The positioning unit 28 outputs a location of the smartphone 20 as positional information indicating longitude and latitude thereof.

The positioning unit 28 may be a GPS. However, as long as the location of the smartphone 20 can be specified, the positioning unit 28 can be optionally configured.

For example, a method of positioning it based on the status of reception radio waves at a plurality of base stations for cell phones, and/or another method may be used instead.

The positional information may include not only items of two-dimensional longitude and latitude but also items of an altitude and/or height.

The print-controlling unit 29a functions as a seventh unit transmitting the optical read information based on an order history to a printer (not shown) via the wireless communication unit 21 to make the printer print the transmitted information.

The mail-transmitting unit 29b functions as an eighth unit transmitting the optical read information based on the order history to a friend, who will become a new orderer, via the wireless communication unit 21 by e-mail.

The upload unit 29c functions as a ninth unit transmitting the optical read information based on the order history to a site where manages social networking services.

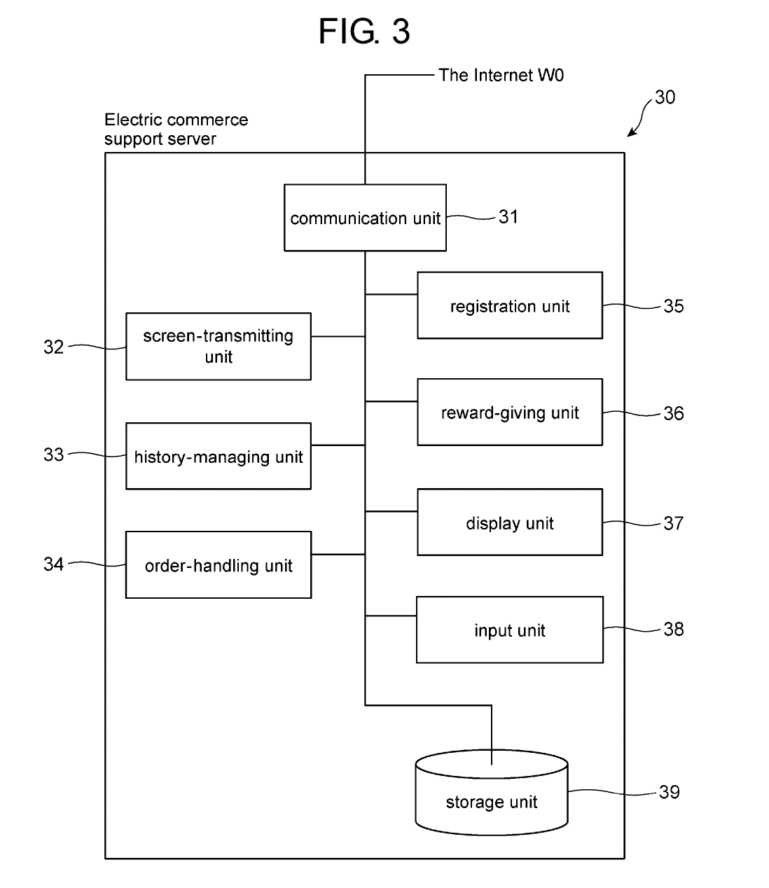

As shown in FIG. 3, the electric commerce support server 30 is a server machine that articles/services sold by vendors have been registered therein.

In this Embodiment 1, electronic commerce support programs have been installed onto the server machine, and are kept running thereon, thereby making the server machine function as the electric commerce support server 30.

The electric commerce support server 30 comprises: a communication unit 31; a screen-transmitting unit 32; a history-managing unit 33; an order-handling unit 34; a registration unit 35; a reward-giving unit 36; a display unit 37; an input unit 38; and a storage unit 39.

The communication unit 31 outputs transmitting data to the Internet W0, and inputs receiving data from the Internet W0.

In response to request from smartphone 20 the screen-transmitting unit 32 reads display screen information from the storage unit 39 to transmit it to the smartphone 20.

The history-managing unit 33 stores order history information indicating an ordered article/service (an order history) onto the storage unit 39.

In response to request for a history screen from the smartphone 20, the history-managing unit 33 reads the order history information from the storage unit 39 to generate history screen information including a list of the order history information, thereby transmitting the generated information to the smartphone 20.

The order-handling unit 34 settles the article/service ordered according to settlement information which shows a method of settlement and is registered on the storage unit 39.

The registration unit 35 handles: member registration of orderers; registration of vendors; and registration of articles/services.

The reward-giving unit 36 functions as a fifth unit giving an introducer and/or an orderer a success reward according to an amount of an ordered article/service.

The display unit 37 may be an LCD, an organic EL, or a CRT for displaying data to be displayed.

The input unit 38 may be a keyboard, a mouse, and so on.

The storage unit 39 thereon stores: personal information of orderers (introducers) registered as members; vendor information of vendors selling articles/services; article/service information of articles/services to be sold; order history information of ordered articles/services; and image information.

The personal information of the orderers (introducers) relates to: information entered upon member registration including: full-name information; address information; telephone number information; delivery destination information; settlement information; e-mail address information; and success reward information; and person identification information assigned by the registration unit 35 upon the member registration has been completed.

The person identification information is used as orderer identification information upon ordering an/a article/service, and is used as introducer identification information upon introducing the ordered article/service to another orderer.

The success reward information indicates a success reward to be given, when the first orderer (as an introducer) has introduced the article/service ordered by himself/herself to another second orderer and the other second orderer orders the same ordered article/service.

The settlement information may include credit card-storing items issued by a credit company of: owner's name information; card number information; and expiration date information, for example.

The vendor information relates to: information entered upon company registration including: company name information; address information; representative full-name information; and person-in-charge information; and company identification information assigned by the registration unit 35 to identify the vendor upon the company registration has been completed.

The person-in-charge information relates to: office information; e-mail address information; and telephone number information.

The article/service information relates to: information entered upon article/service registration including: article/service name information; image file showing contents of the article/service; explanation information; price information; effective date information; partner information showing the vendor's partner; and advertisement identification information for identifying an advertising medium; and other information assigned by the registration unit 35 to identify the article/service upon the article/service registration has been completed including: article/service identification information; introducer success reward information; and orderer success reward information.

The effective date information shows an effective date of order for an/a article/service.

The effective date information is defined using an effective start date (effective start information) and an expiration date (expiration date information).

If the current date and time are over the term of validity shown by the effective start information included in the effective date information, the order has been effective and the expiration date information shows the expiration date.

The introducer success reward information shows a success reward to be given to an introducer when the first orderer has become the introducer to introduce the ordered article/service to a second new orderer, and further when the second new orderer orders the introduced article/service.

The orderer success reward information shows a success reward to be given when the new second orderer orders the introduced article/service.

The orderer success reward information relates to: information indicated by a two-dimensional bar code read upon ordering; order date information; positional information; and person identification information of the orderer.

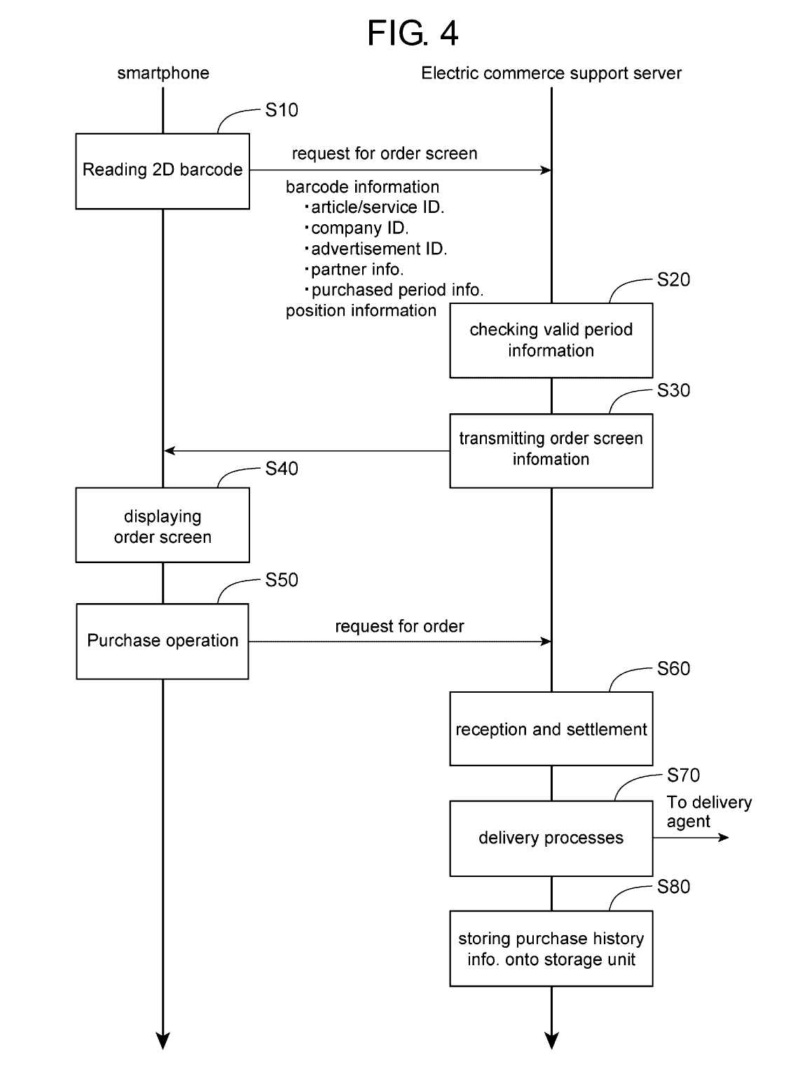

Referring to FIG. 4, operation states and usage states of the electric commerce support system constituted as mentioned above in Embodiment 1 according to the present invention will now be explained.

In this Embodiment 1, it is assumed that member registration of the orderer has been completed.

It is also assumed that both company registration and article/service registration with respect to the vendor have been completed.

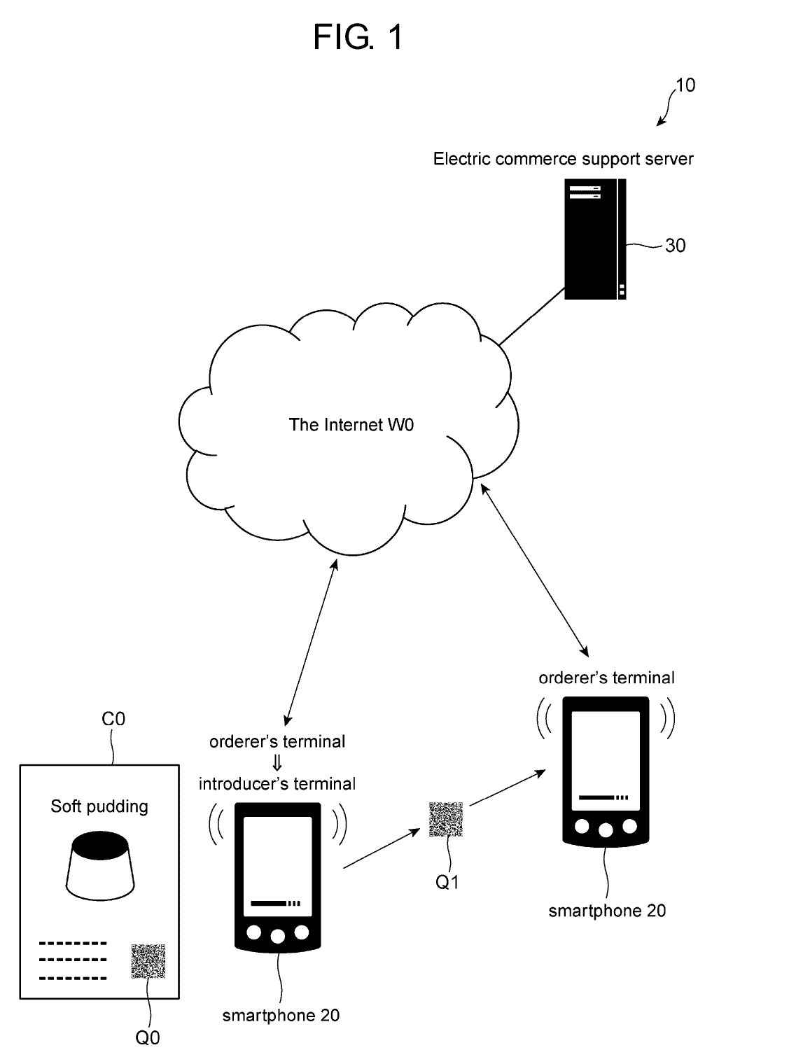

When an orderer sees an acquired flier CO shown in FIG. 1 to get interested in a pudding which is an example of articles published on the flier C0, thereby deciding to place order for the pudding, the orderer turns the orderer's smartphone 20 towards a two-dimensional bar code Q0 printed on the flier CO to read it.

In the smartphone 20, the reading unit 22 reads and analyzes the two-dimensional bar code Q0.

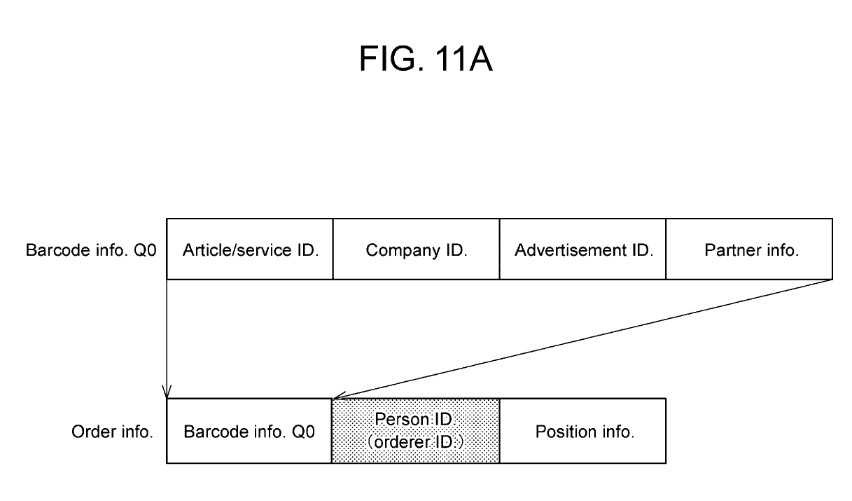

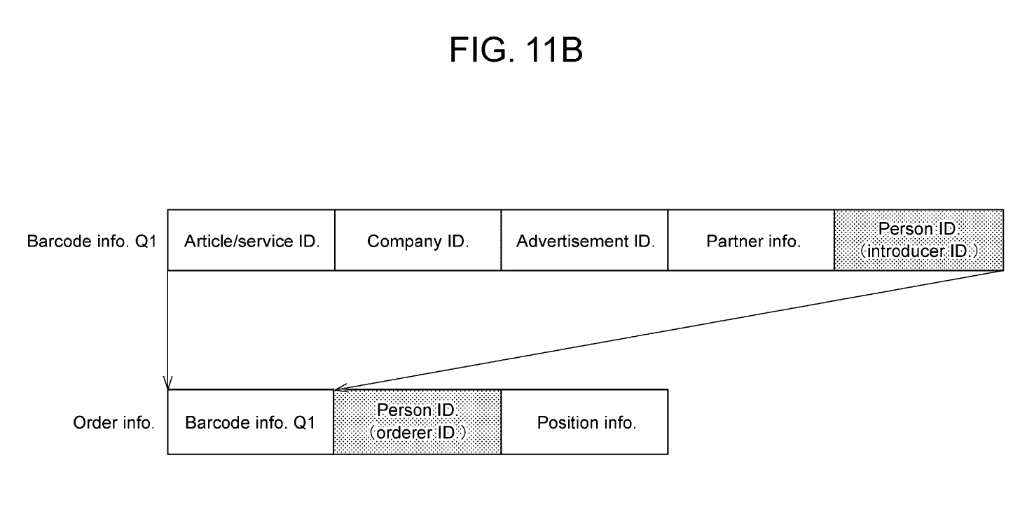

As shown in FIG. 11A, the two-dimensional bar code Q0 is printed on the flier C0, and contains figured and issued bar code information including: article/service identification information; company identification information; advertisement identification information; and partner information.

The reading unit 22 transmits order information (See, FIG. 11A.) as request for order screen via the wireless communication unit 21 to the address on the network of the electric commerce support server 30 (Step S10).

The order information includes: information analyzed by the reading unit 22 according to the two-dimensional bar code Q0; person identification information (orderer identification information) for identifying the orderer who operates the smartphone 20; and positional information containing such as longitude and latitude of the smartphone 20 inputted from the positioning unit 28.

When the electric commerce support server 30 receives the request for order screen transmitted by having read the two-dimensional bar code Q0, firstly, the order-handling unit 34 checks valid period information (Step S20).

The valid period information is obtained in a manner such that the order-handling unit 34 searches the storage unit 39 based on the article/service identification information transmitted from the smartphone 20 to read information related thereto.

The valid period information is checked by judging both of: whether or not the current date and time of the request from the smartphone 20 are over the term of validity shown by the effective start information; and whether or not the current date and time of the request are over the expiration date shown by the expiration date information.

When the order-handling unit 34 judges that the current date and time when the orderer handling the smartphone 20 tries to place are not within the valid period shown by the valid period information, the order-handling unit 34 notifies the judgment result to the smartphone 20.

The order-handling unit 34 may transmit a notice screen showing that order for the article/service related to the article/service identification information indicated by the two-dimensional bar code Q0 is not available, for example.

If the current date and time when the electric commerce support server 30 receives the request for order screen are within the valid period, the screen-transmitting unit 32 reads the order screen information from the storage unit 39 based on the article/service identification information from the smartphone 20 to transmit it to the smartphone 20 (Step S30).

In the smartphone 20, the browsing unit 23 receives the order screen information of the article/service corresponding to the article/service identification information from the electric commerce support server 30, and displays the order screen on the display unit 25 (Step S40).

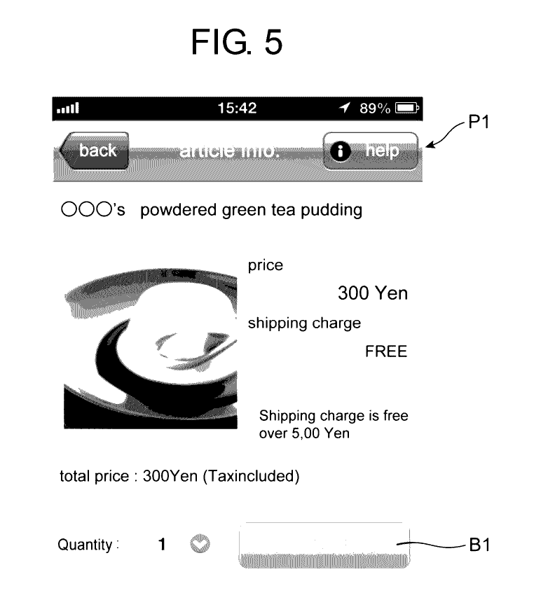

FIG. 5 shows an order screen P1 displayed on the display unit 25 according to the order screen information.

FIG. 5 shows an example of the order screen P1 in a case where the article capable of being ordered is a pudding.

It is assumed that the orderer decides to order the pudding after the orderer has viewed the photograph, the explanation, and the price of the pudding included in the order screen P1 displayed on the display unit 25.

As order operation, the orderer specifies the quantity and taps the “purchase” button B1 which is an order button displayed on the order screen P1 to be pressed.

This order operation causes the request-informing unit 24 to transmit request for order to the electric commerce support server 30 (Step S50).

In the electric commerce support server 30, the order-handling unit 34 performs: reception of the order for the pudding indicated by the article/service identification information included in ordering information from the smartphone 20; and settlement based on settlement information corresponding to the person identification information (orderer identification information) (Step S60).

The order-handling unit 34 may transmit a notice of settlement to a server managed by a credit company, for example.

In response to the reception of the order, e-mail is transmitted based on the e-mail address information to the person-in-charge belonging to the vendor. The email has text including: name information of the “pudding”; the article/service identification information indicating the pudding; quantity information showing the quantity of the pudding(s); orderer's full-name information; delivery destination information; and information of the person-in-charge. Thereby, the order-handling unit 34 notifies the vendor that the order of the pudding based on the ordering information has been received.

The vendor performs delivery processes according to the transmitted e-mail (Step S70).

The history-managing unit 33 stores order history information related thereto onto the storage unit 39. The order history information includes: bar code information containing article/service identification information of the article/service (in this case, the “pudding”) ordered by the request for order from the smartphone 20; and the ordered date and time information showing the ordered time (year/month/date/time) (Step S80).

The two-dimensional bar code includes not only the article/service identification information identifying an/a article/service but also the advertisement identification information.

And, the history-managing unit 33 accumulates the advertisement identification information for every order onto the storage unit 39. Accordingly, the vendor can statistically analyze which type of advertising media (among posters, fliers, newspapers, magazines, and TV broadcasting, or the like) is used to issue order more.

Upon placing the order, the smartphone 20 transmits the positional information showing the position where the smartphone 20 is located to the electric commerce support server 30.

So, the vendor can judge which area among various areas where posters are pasted and/or where fliers are distributed is used to order based on the positional information.

In this way, the vendor can use the positional information so as to analyze which area among the various areas is the most effective.

The order-handling unit 34 may specify the position where the orderer has placed the order according to the positional information, and may determine whether or not the order is available based on the specified position. If so, the order-handling unit 34 can regionally limit order for articles/services.

The two-dimensional bar code also includes the partner information.

Therefore, the vendor can give a predetermined rate of sales related to the ordered article/service as a bonus to the vendor's partner company.

For example, when the partner company is a printing company producing fliers and/or posters, the printing company is encouraged to produce better fliers and/or posters, since the printing company can get the bonus according the sales.

The vendor may produce fliers and/or posters cheaply instead of giving the bonus according to the sales.

Furthermore, the valid period information is included in the article/service information stored on the storage unit 39.

If there is a fact that fliers and/or posters have been left over the expiration date of articles/services supplied by the vendor and the orderer tries to place order related thereto without knowing the fact, the order-handling unit 34 can check the valid period information to prevent the articles/services from being accidentally ordered.

Or, if the flier CO is distributed to the orderer so as to notify the articles/services to him/her in advance of the term of validity, the articles/services also can be prevented from being accidentally ordered.

More concretely, this method of limiting a sale of the articles/services within the valid sales period is preferable for cases where a supplying period should be limited for sale, such as tickets for a concert, tickets for a play, tickets for a show, tickets for exhibition, duration limited merchandise, and so on.

The valid period information may also be included in the two-dimensional bar code.

When the two-dimensional bar code includes the valid period information, the electric commerce support server 30 does not have to search the storage unit 39 based on the article/service identification information to retrieve the valid period information related to the article/service identification information. Therefore, the burden of the electric commerce support server 30 can be reduced.

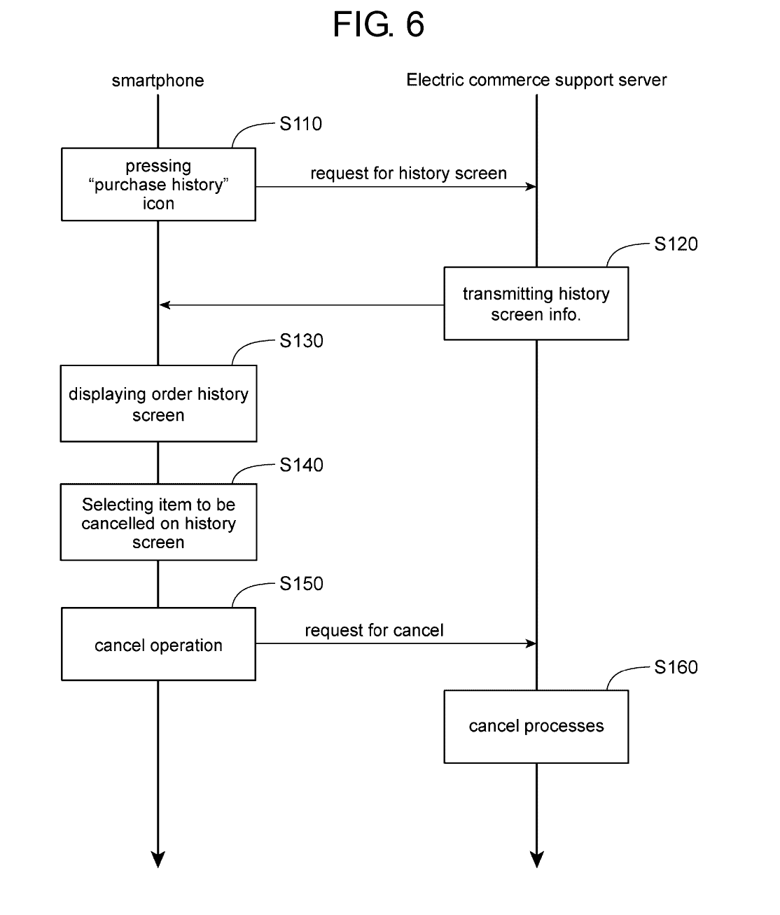

Next, referring to from FIG. 6 to FIG. 10, processes using an order history screen displaying a list of articles/services ordered by an orderer will now be explained.

When the orderer wants to see the history of the ordered articles/services, the orderer taps (presses) the “order history” icon displayed on the display screen.

This operation causes the request-informing unit 24, which functions as a history-requesting unit, to transmit request for a history screen to the electric commerce support server 30 (Step S110).

In response to the request for the history screen from the smartphone 20, the history-managing unit 33 of the electric commerce support server 30 reads the order history information (an order history) from the storage unit 39, and transmits the history screen information including a list of the order history information to the smartphone 20 (Step S120).

The browsing unit 23 of the smartphone 20 receives the history screen information from the electric commerce support server 30, and displays it on the display unit 25 (Step S130).

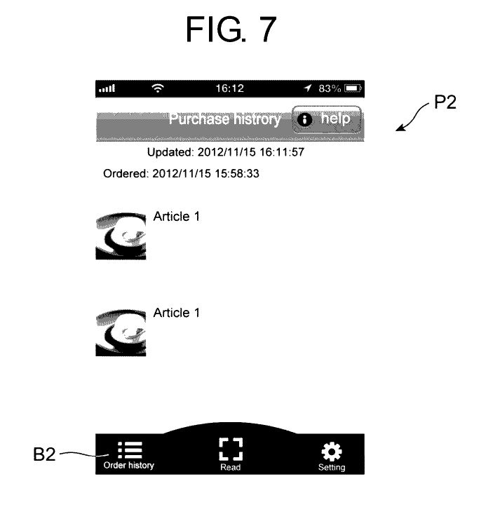

FIG. 7 shows an example of an order history screen based on the history screen information displayed on the display unit 25.

FIG. 7 shows an example of an order history screen P2 including two cases each of which a pudding as an article has been ordered in the past.

At a lower part of the order history screen P2 shown in FIG. 7, an order history icon B-2 is displayed.

Furthermore, in FIG. 7, a message saying the two items of ordered puddings can be cancelled is displayed thereon.

Ordered articles/services can be cancelled within a predetermined period (e.g., 30 minutes) from the respective ordered time.

The orderer reads the message saying the items can be cancelled in the order history screen P2 displayed on the display unit 25, and taps the touch panel of the input unit 26 to select an/a article/service to be cancelled, thereby performing history-selecting operation on the respective order history information.

The history-selecting operation causes a cancel screen to be displayed on the display unit 25 (Step S140).

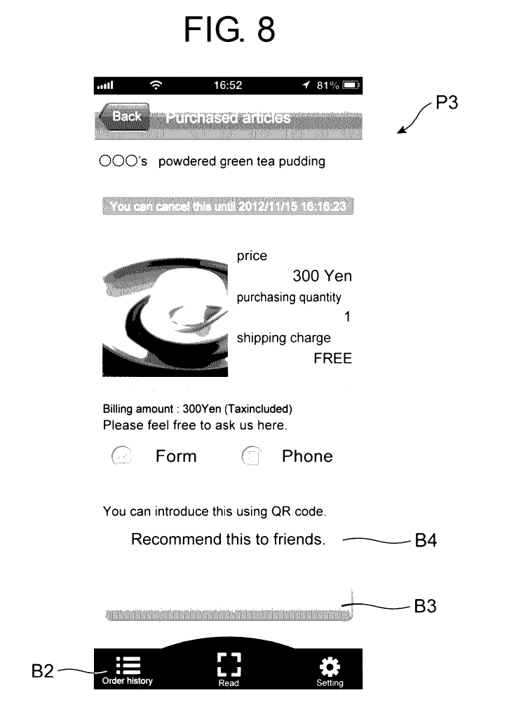

FIG. 8 shows an operation screen displayed on the display unit 25.

A “cancel to purchase” button B3 is displayed on the operation screen P3 in FIG. 8.

When the orderer taps the “cancel to purchase” button B3 to perform cancel operation, the request-informing unit 24 transmits: request for cancel; the article/service identification information indicating the pudding; and the orderer identification information indicating the orderer to the electric commerce support server 30 (Step S150).

Until the cancellable period has passed, the electric commerce support server 30 keeps reserving reception and settlement with respect to the ordered article/service at Step S60 in FIG. 4.

In response to the request for cancel from the smartphone 20, the order-handling unit 34 performs cancel operation on the reserved reception and settlement with respect to the pudding indicated by the article/service identification information based on the order information (when the order was received) corresponding to the orderer identification information (Step S160).

In this way, the article(s)/service(s) that the orderer has ordered can be easily cancelled within the predetermined period.

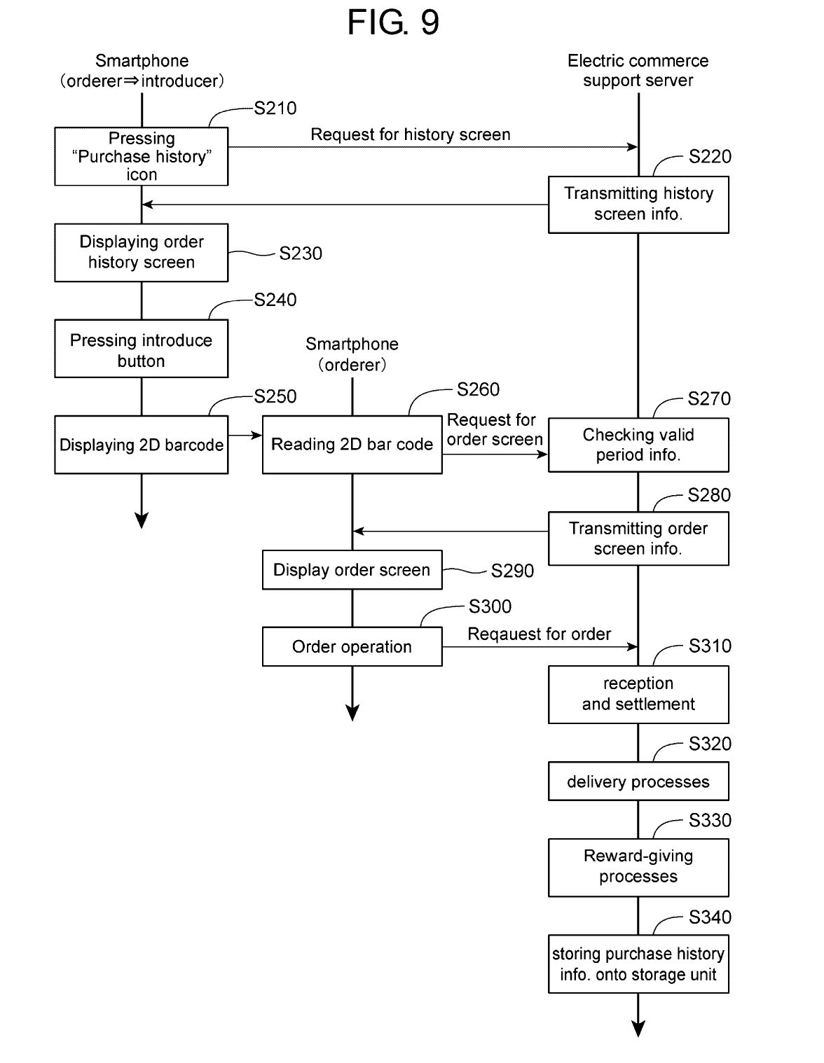

Referring to FIG. 9, a case where the orderer wants to become an introducer, thereby recommending the article/service ordered by himself/herself to his/her family, friends, acquaintances, or the like will now be explained.

Similar to the Step S110 shown in FIG. 6, the orderer, who is also the introducer, taps (presses) the “order history” icon displayed on the display screen.

This operation causes the request-informing unit 24, which functions as a history-requesting unit, to transmit request for a history screen to the electric commerce support server 30 (Step S210).

Similar to the Step S120 shown in FIG. 6, in response to the request for the history screen from the smartphone 20, the history screen information including a list of order history information is transmitted to the smartphone 20. (Step S220).

Similar to the Step S130 shown in FIG. 6, the smartphone 20 receives the history screen information from the electric commerce support server 30 to display it on the display unit 25 (Step S230).

Next, in a state where an operation screen P3 shown in FIG. 8 is displayed (a state of the Step S130 shown in FIG. 6), the orderer taps (presses) a “recommend this to friends” button B4, which is an introduction button displayed on the operation screen P3 (Step S240).

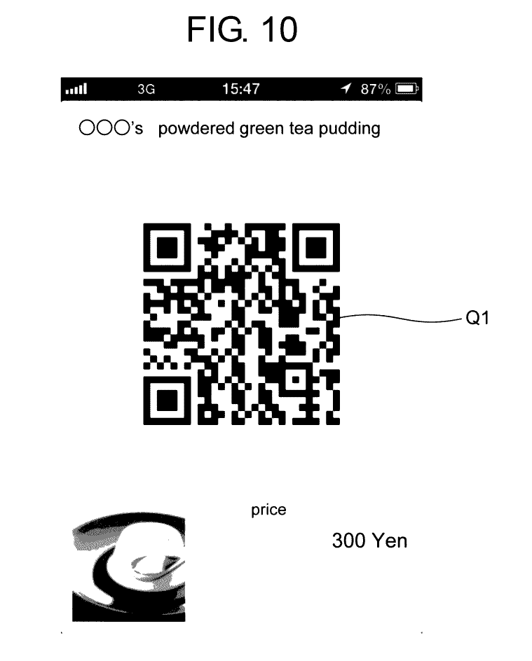

Upon the “recommend this to friends” button B4 of the smartphone 20 has been tapped, as shown in FIG. 10, the optical read information-generating unit 27 generates and displays a two-dimensional bar code Q1 figured according to bar code information on the display unit 25 (Step S250).

The two-dimensional bar code Q printed on the flier CO shown in FIG. 1 contains the bar code information including: the article/service identification information; the company identification information; the advertisement identification information; and the partner information (See, FIG. 11A.).

As shown in FIG. 11B, the bar code information of the two-dimensional bar code Q1 further contains introducer identification information indicating the introducer as person identification information.

The orderer becomes an introducer, operates the smartphone 20 functioning also as an introducer's terminal, and shows the two-dimensional bar code Q1 displayed on the display unit 25 to his/her acquaintance, for example.

Then, the acquaintance becomes a new orderer, operates the smartphone 20 functioning also as a new orderers terminal, and makes the reading unit 22 read the two-dimensional bar code Q1.

The reading unit 22 of the smartphone 20 operated by the new orderer reads and analyzes the two-dimensional bar code Q1.

Similar to the Step S10 shown in FIG. 4, the reading unit transmits order information (See, FIG. 11B.) as request for order screen via the wireless communication unit 21 to the address on the network of the electric commerce support server 30 (Step S260).

The order information includes: information analyzed by the reading unit 22 according to the two-dimensional bar code Q1; person identification information (orderer identification information) for identifying the orderer who operates the smartphone 20; and positional information containing such as longitude and latitude of the smartphone 20 inputted from the positioning unit 28.

When the electric commerce support server 30 receives the request for order screen transmitted by having read the two-dimensional bar code Q1, firstly, the order-handling unit 34 checks valid period information (Step S270).

If the current date and time when the electric commerce support server 30 receives the request for order screen are within the valid period, similar to the Step S30 shown in FIG. 4, the screen-transmitting unit 32 reads the order screen information from the storage unit 39 based on the article/service identification information from the smartphone 20 to transmit it to the smartphone 20 (Step S280).

Similar to the Step S40 shown in FIG. 40, in the smartphone 20, the browsing unit 23 receives the order screen information of the article/service corresponding to the article/service identification information from the electric commerce support server 30, and displays the order screen on the display unit 25 (Step S290).

As order operation, the new orderer specifies the quantity and taps the “purchase” button B1 which is an order button displayed on the order screen P1 (See, FIG. 5.) to be pressed.

Similar to the Step S50, this order operation causes the request-informing unit 24 to transmit request for order to the electric commerce support server 30 (Step S300).

Similar to the Step S60 shown in FIG. 4, in the electric commerce support server 30, the order-handling unit 34 performs: reception of the order for the pudding indicated by the article/service identification information included in ordering information from the smartphone 20; and settlement based on settlement information corresponding to the person identification information (orderer identification information) (Step S310).

The order-handling unit 34 may transmit a notice of settlement to a server managed by a credit company, for example.

Similar to the Step S70 shown in FIG. 4, the order-handling unit 34 notifies the vendor's person in charge of request for delivery by e-mail (Step S320).

The reward-giving unit 36 of the electric commerce support server 30 adds the introducer success reward information according to the price information to the success reward information related to the person identification information as the introducer identification information included in the two-dimensional bar code Q1 contained in the order information. Thereby, the added success reward is given to the introducer as an incentive.

The reward-giving unit 36 also adds the orderer success reward information according to the price information to the success reward information related to the person identification information as orderer identification information included in the order information. Thereby, the added success reward is also given to the new orderer as an incentive (Step S330).

In this Embodiment, the reward-giving unit 36 gives 2% points of the value shown by the price information to the introducer as the success reward for the introducer, and gives 1% points of the value shown by the price information to the orderer as the success reward for the orderer.

In this Embodiment, the success rewards are handled with the points, and the points also can be used upon issuing the next order, or the like. The success rewards given by the reward-giving unit 36, however, may be given with electronic money, and so on instead thereof.

Similar to the Step S80 shown in FIG. 4, the order history is stored onto the storage unit 39. The order history information includes: the bar code information containing the article/service identification information of the article/service (in this case, the “pudding”) ordered by the request for order from the smartphone 20; and the ordered date and time information showing the ordered time (year/month/date/time) (Step S340).

In this way, since the optical read information-generating unit 27 issues the two-dimensional bar code Q1 according to the order history, the introducer does not have to possess specialized knowledge.

The orderer has become a new introducer. And, his/her acquaintance becomes a new orderer, and can comfortably order the ordered pudding.

Therefore, the introducer can easily recommend the ordered article/service to his/her friends, acquaintances, family, and so on.

The article/service identification information transmitted by the history-managing unit 33 to the smartphone 20 may be updated into a new value from that of the article/service identification information indicated by the two-dimensional bar code Q0 which the first orderer has read from the flier C0.

This is because such updating the value enables to identify the two-dimensional bar code is derived from either a flier/poster produced by the vendor or an image displayed on the smartphone 20.

For example, a specific flag included in the article/service identification information may be validated, and/or it is further conceivable to implement a counter for showing how many times the two-dimensional bar code has been transmitted between orderers thereon.

In this way, updating the article/service identification information enables to analyze effects caused by word of mouth communications.

As mentioned above, according to the electric commerce support system 10 in Embodiment 1, the orderer reads the article/service identification information from the two-dimensional bar code Q0 displayed on the advertising medium of the smartphone 20, transmits the read information to the address on the network of the electric commerce support server 30, thereby the orderer can order the article/service according to the order screen information. In other words, the orderer does not have to perform complicated operation such as entering the article/service to be ordered into a cart, and/or, performing settlement related thereto.

The smartphone 20 transmits the article/service identification information read from the two-dimensional bar code Q0 to the address, which already has been set up in the smartphone 20, on the network of the electric commerce support server 30.

The orderer can save himself/herself tapping the screen displaying the URL indicated by the two-dimensional bar code Q0. So, complicated operation is reduced more.

In the electric commerce support system 10, the electric commerce support server 30 installed in the electronic commerce office performs account settlement processes. It is unnecessary for a vendor's homepage to be provided with functions of performing the account settlement processes. It is sufficient that the vendor's homepage merely includes a page for introducing orderable articles/services therefrom.

In the above, the example that the orderer purchases the pudding sold by the vendor has been explained. The electric commerce support system 10, however, may also be used for requesting catalogues including no article to be sold therein.

If so, firstly, the first orderer requests a catalogue. Secondly, the first orderer becomes an introducer to introduce the same catalogue. Thirdly, a new second orderer requests the same catalogue. Then, the first orderer can get a reward.

The orderer may not request the catalogues, which are free goods, but apply account opening to financial institution based on the personal information registered on the electric commerce support server 30.

In the case, it is preferable to thereon register information necessary for the account opening including: company/school information; and company/school contact address information, in addition to: full-name information; address information; telephone number information; delivery address information; settlement information; and e-mail address information.

The orderer can introduce the account opening to other orderers using the two-dimensional bar code so as to spread it.

Furthermore, the electric commerce support system 10 may present reservation services instead of handling the request for the catalogues.

As long as capable of being reserved, all kinds of services can be employed for reserving: tickets for a lecture; tickets for theatergoing; tickets for a concert; tickets for a railroad; and tickets for a plane; accommodation; or the like.

In any case in the same way, the orderer also can introduce the reservation to other orderers using the two-dimensional bar code so as to spread it.

In the above example, the optical read information-generating unit 27 of the smartphone 20 has issued the two-dimensional bar code as the optical read information, and has made the display unit 25 display it thereon, and has introduced the ordered article/service to the new orderer.

The optical read information-generating unit 27 however, may output the optical read information onto a medium using a printer (not shown) via the print-controlling unit 29a.

The introducer can massively print the optical read information (for example, See the two-dimensional bar code Q1 in FIG. 10) showing the ordered article/service to be recommended to others to distribute them. As a result, the introducer can get the reward more frequently.

The optical read information-generating unit 27 may also transmit the optical read information by e-mail via the mail-transmitting unit 29b.

If so, the introducer can paste the optical read information showing the ordered article/service to be recommended to his/her acquaintance, who will newly become an orderer, onto HTML mail, and/or or can attach the information to text e-mail as an attached file to distribute it/them. As a result, the introducer can get the reward more frequently.

The new orderer can easily order the ordered article/service by: reading the optical read information printed onto the medium caused by the reading unit 22 of the smartphone 20 functioning as the orderers terminal; and/or reading the optical read information notified using the e-mail.

Furthermore, the optical read information-generating unit 27 may upload the optical read information to at least one of sites managing social network services via the upload unit 29c.

The sites may be FACEBOOK (registered trademark), TWITTER (registered trademark), LINE (registered trademark), or the like.

The introducer can upload the optical read information showing the ordered article/service to be recommended to others to the sites managing the social networking services to widely spread it thereby. As a result, the introducer can get the reward more frequently.

Firstly, a new orderer accesses at least one of the sites managing the social networking services using his/her personal computer, or the like.

Secondly, the new orderer reads the optical read information displayed on a screen using the reading unit 22 of the smartphone 20 functioning as the new orderer's terminal And then, the new orderer can easily order the ordered article/service.

### INDUSTRIAL APPLICABILITY

The present invention is preferably employed for sites of electric stores selling articles/services. This is because the orderer can comfortably order the article/service introduced by the introducer.

The introducer does not have to possess specialized knowledge with respect to computers. Therefore, anyone can access to the electric commerce support system according to the present invention as an introducer.

1. An electric commerce support system, comprising:
a first terminal operated by an introducer introducing an/a article/service that the introducer has been ordered;
a second terminal operated by an orderer ordering the introduced article/service in response to introduction from the first terminal; and
a server supporting electronic commerce that gives the introducer a success reward in response to order from the second terminal,
wherein:
the first terminal comprises:
a first unit requesting the server to transmit an order history; and
a second unit issuing optical read information including first identification information identifying the ordered article/service based on the order history transmitted from the server, second identification information identifying the introducer, and including information indicating how many times the optical read information has been transmitted between orderers,
the second terminal comprises:
a third unit reading the optical read information issued by the second unit; and
a fourth unit generating order information according to both positional information showing a location of the second terminal and the optical read information read by the third unit to transmit the generated order information to the server, thereby requesting order; and
the server comprises a fifth unit giving the introducer the success reward according to the second identification information included in the order information transmitted by the fourth unit.

2. The electric commerce support system as defined in claim 1, wherein:
the order information further includes orderer identification information identifying the orderer; and
the fifth unit of the server gives the orderer the success reward according to the orderer identification information.

3. The electric commerce support system as defined in claim 2, wherein the first terminal further comprises a sixth unit displaying the optical read information issued by the second unit.

4. The electric commerce support system as defined in claim 1, wherein the first terminal further comprises a seventh unit making a printer print the optical read information issued by the second unit.

5. The electric commerce support system as defined in claim 1, wherein the first terminal further comprises an eighth unit transmitting the optical read information issued by the second unit via e-mail.

6. The electric commerce support system as defined in claim 1, wherein the first terminal further comprises a ninth unit transmitting the optical read information issued by the second unit to a site where manages social network services.

7. The electric commerce support system as defined in claim 2, wherein the first terminal further comprises a seventh unit making a printer print the optical read information issued by the second unit.

8. The electric commerce support system as defined in claim 3, wherein the first terminal further comprises a seventh unit making a printer print the optical read information issued by the second unit.
